(19) United States
(12) Patent Application Publication
(10) Pub. No.: US 2017/0052626 A1
(43) Pub. Date: Feb. 23, 2017

(54) Touch Sensing Device Capable of Detecting Speed

(71) Applicant: Acer Incorporated, New Taipei City (TW)

(72) Inventor: Chang-Hsu Chen, New Taipei City (TW)

(21) Appl. No.: 15/013,154

(22) Filed: Feb. 2, 2016

(30) Foreign Application Priority Data
Aug. 17, 2015 (TW) 104126758

(51) Int. Cl. G06F 3/041; G06F 3/044

(52) U.S. Cl. CPC G06F 3/0416; G06F 3/044

(57) ABSTRACT

A touch apparatus and a touch detecting method thereof are provided. The touch detecting method includes setting a first capacitance level for the touch panel, setting a second capacitance level for the touch panel, wherein the first capacitance level is higher than the second capacitance level, detecting a touch event with respect to the first capacitance level at a first time, detecting the touch event with respect to the second capacitance level at a second time, and determining a speed at which the touch event occurred by determining a time difference between the first time and the second time.

### RELATED APPLICATION DATA

This application claims priority under 35 U.S.C. §119 to Taiwan patent application TW 104126758, filed on Aug. 17, 2015, the disclosure of which is incorporated herein by reference in its entirety.

### TECHNICAL FIELD

The present invention relates to touch technology, and in particular relates to a methodology by which to detect the speed of a given touch event on a touch panel of a touch device.

### BACKGROUND

With the development and progress of touch screen technology, the touch screen panel (“touch panel”) is now widely used for mobile phones, notebook computers, tablet PCs and other electronic devices. Easy and intuitive to operate, touch panel features have generated unprecedented popularity for touch devices among consumers.

With present capacitive touch panel technology, in order to determine whether a touch event has occurred, changes in capacitance values on the surface of the touch panel are detected. Typically, the amount of capacitive is set to a given value, and whether a touch occurs is determined by whether the capacitance has changed from that given value (and with respect to a predetermined threshold). FIGS. 1 and 2 depict plots of capacitive sensing levels of a conventional touch panel. FIG. 1 illustrates a capacitive sensor and capacitance levels between respective electrodes 105. As can be seen, the electric fields 110, 120, 130 extending from the electrodes 105 are at a first, and consistent, level. FIG. 2 also illustrates a capacitive sensor and capacitance levels between respective electrodes 105. As can be seen, the electric fields 210, 220, 230 extending from the electrodes 105 are at a second relatively higher, and consistent, level, compared to the first level shown in FIG. 1. As between the two implementations, the implementation of FIG. 2 can provide higher touch detection sensitivity due to the higher capacity/electric field.

The above implementations set the amount of capacitive sensing (electric field strength) at a consistent strength. One reason to do so is to avoid environmental noise interference that can result in false positive touch events. A drawback of the conventional capacitive touch panel, however, is that there is no way to detect the speed at which a touch occurs.

### SUMMARY

In view of foregoing, the present invention provides a touch device and touch detection method which can accurately detect the speed at which a touch event occurs on a touch panel, allowing touch devices to have additional features thereby enhancing a user's experience.

The present invention provides a method for touch detection. The method includes setting a first capacitance level for the touch panel, setting a second capacitance level for the touch panel, wherein the first capacitance level is higher than the second capacitance level, detecting a touch event with respect to the first capacitance level at a first time, detecting the touch event with respect to the second capacitance level at a second time, and determining a speed at which the touch event occurred by determining a time difference between the first time and the second time.

The present invention also provides a touch device that includes a touch panel and a processor coupled to the touch panel, wherein the processor is configured to set a first capacitance level for the touch panel, set a second capacitance level for the touch panel, wherein the first capacitance level is higher than the second capacitance level, detect a touch event with respect to the first capacitance level at a first time, detect the touch event with respect to the second capacitance level at a second time, and determine a speed at which the touch event occurred by determining a time difference between the first time and the second time.

### BRIEF DESCRIPTION OF THE DRAWINGS

Embodiments are described herein in conjunction with the accompanying drawings, in which:

FIGS. 1 and 2 depict relative strengths of electric fields generated between electrodes of a touch panel that are used in a capacitive touch panel according to the prior art.

FIG. 3 is a block diagram of a touch device according to one embodiment of the present invention.

FIG. 4 depicts a flow chart consistent with a method of detecting a touch event according to an embodiment of the present invention.

FIG. 5 is a schematic view of different levels of electric fields and corresponding amounts of capacitance employed in a single touch panel according to an embodiment of the present invention.

FIG. 6 depicts different detection positions for a touch event that enables a calculation of the speed of the touch event.

FIG. 7 depicts a flowchart consistent with a touch detection method in accordance with an embodiment of the present invention.

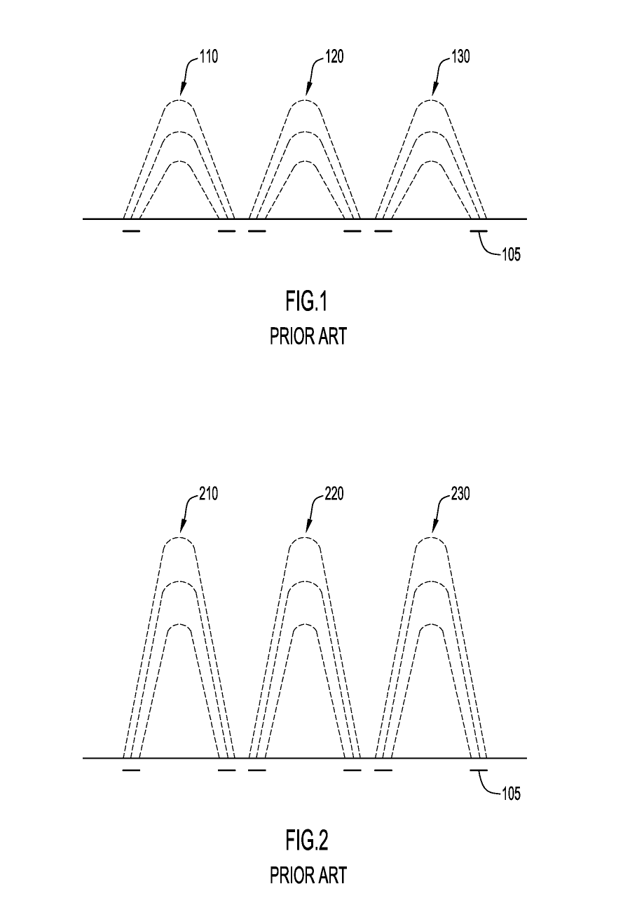

### DESCRIPTION OF EXAMPLE EMBODIMENTS

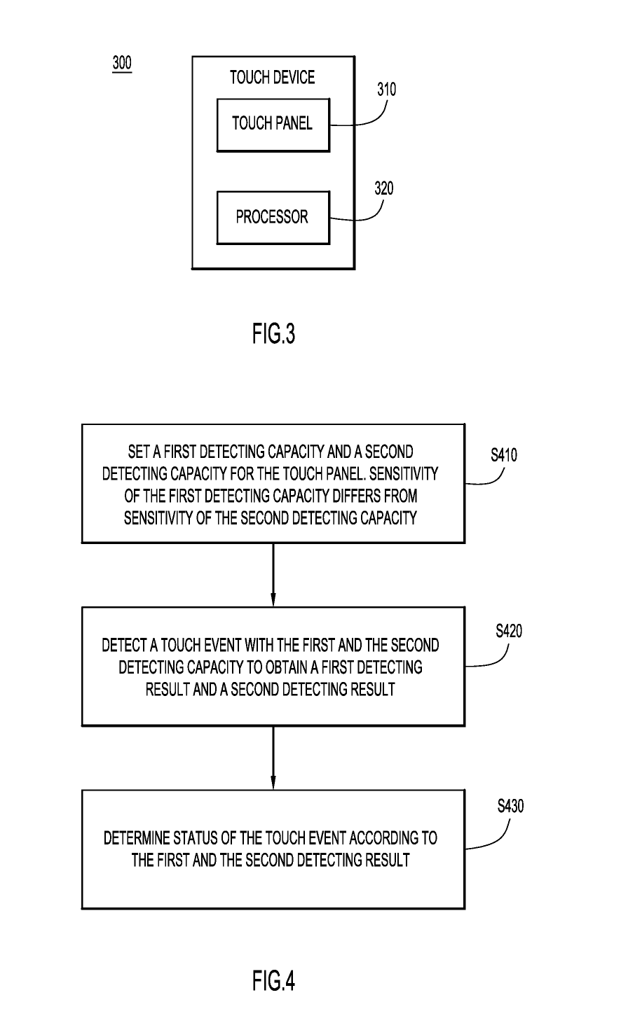

FIG. 3 is a block diagram of a touch device in accordance with an embodiment of the present invention. As shown, touch device 300 is an electronic device having computational functionality such as is embodied in, for example, desktop computers, notebook computers, tablet PCs, smart phones, etc. Those skilled in the art will appreciate that the foregoing list of devices is purely exemplary and is not intended to limit the scope of the invention. Touch device 300 includes a touch panel 310 and processor 320, which are configured to function as described below.

Touch panel 310 may be a capacitive, optical, ultrasonic type touch panel and may be combined with a display such as, for example, a liquid crystal display (LCD), light emitting diode (LED) display, a field emission display (FED), or other type of display.

Processor 320 may be, for example, a central processing unit (CPU), or other general purpose programmable microprocessor or special purpose microprocessor, digital signal processor (DSP), programmable controller, application-specific integrated circuit (ASIC), programmable logic device (PLD), or other similar device, or a combination of such devices. In the present embodiment, processor 320 may control the overall operation of touch device 300, and receive from touch panel 310, touch information for processing in accordance with the methodology described herein.

In addition, touch device 300 may also include a storage device (not shown). The storage device may be used to store data, e.g., touch events, and any other information received from touch panel 310. The storage device may be, for example, any type of fixed or removable random access memory (RAM), read only memory (ROM), flash memory, hard disk or other similar device, and/or combinations of such devices.

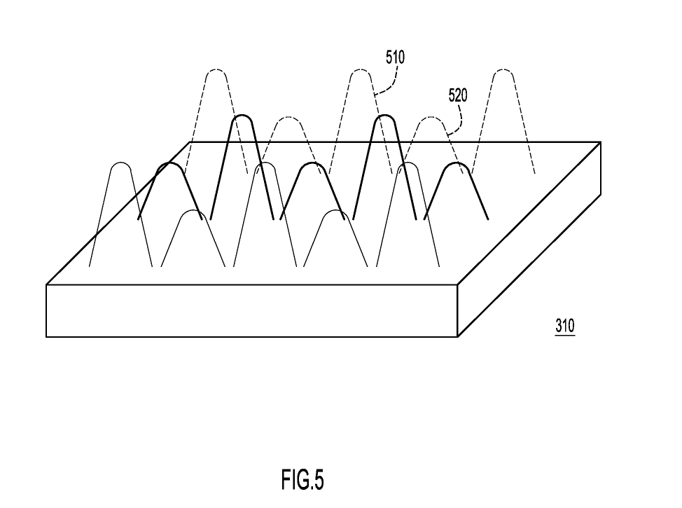

FIG. 4 depicts a flowchart of a touch detection method in accordance with an embodiment of the present invention that can be performed with touch device 300 of FIG. 3.

At step S410, processor 320 is configured to set a first detecting capacity and a second detecting capacity for touch panel 310. A sensitivity of the first detecting capacity is different from the sensitivity of the second capacity.

More specifically, processor 320 or the physical configuration of electrodes disposed on touch panel 310 may be configured to provide two different capacity levels in a given touch panel. In this regard, reference is made to FIG. 5, which is a view of different levels of electric fields and corresponding amounts of capacitance combined in a single touch panel according to an embodiment of the present invention. In the present embodiment, processor 320 may be configured, or touch panel 310 may be configured, to set two different capacitive levels on touch panel 310, namely a first relatively higher capacitance level (electric field) 510, and a second relatively lower capacitance level (electric field) 520. These capacitance levels are closely intermingled as shown in FIG. 5 such that both capacitance levels would be impacted by a single touch event. The different capacitance levels may also be generated in a time-division multiplexing manner, as is described later herein.

There are several different ways to generate the different levels of electric fields/capacitance 510, 520. For example, in one embodiment, touch panel 310 may employ different materials having different dielectric constant characteristics for different electrodes, thereby causing those electrodes to demonstrate different capacitive characteristics. In other words, in the present embodiment, touch panel 310 may include a plurality of first detection electrodes and a plurality of second detection electrodes, where the first detection electrodes are formed by a first material, and pairs of such electrodes may generate a first capacitance level 510 between the electrodes. The second detection electrodes may be formed of a second material, and pairs of such electrodes may generate a second capacitance level 520.

In addition, in other embodiments, dielectric layer thickness, area, and other characteristics of the electrodes can influence the level of demonstrated capacitance.

In other possible embodiments, processor 320 may be configured to adjust the capacitance levels via, e.g., firmware. More specifically, in one embodiment, processor 320 may be configured to adjust the amount of a first and a second capacitance by enabling (i.e., switching in/out) additional electrode area. In another embodiment, processor 320 may be configured to adjust the voltage applied to selected electrodes such that selected pairs of electrodes are subjected to a first applied voltage level and other selected pairs of electrodes are subjected to a second, e.g., lower, applied voltage level. In this way, the relatively higher capacitance level (electric fields) 510 and relatively lower capacitance levels (electric fields) 520 can be generated for different areas of touch panel 310.

In a preferred embodiment, the higher and lower capacitance levels 510, 520 are arranged close enough to one another (in space and/or in time) such that for a given touch event, e.g., by a finger touch, at least one pair or set of electrodes of each capacitance level is impacted. That is, for a given touch event, changes to both capacitance levels are detected by processor 320.

Reference is again made to FIG. 4 in which, as noted above, at step S410, a method includes setting a first detecting capacity and a second detecting capacity for touch panel 310. The sensitivity capacity of the first detecting capacity and the second detecting capacity are different from each other. At step S420, a touch event is detected with respect to the first detecting capacity and the second detecting capacity to obtain a first detecting result and a second detecting result, respectively.

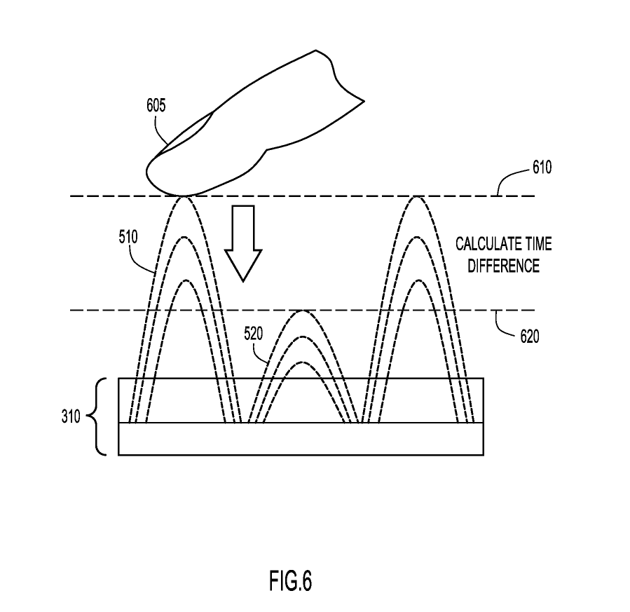

Reference can be made to FIG. 6 for a better understand of the foregoing. As shown in that figure, as a finger 605 approaches touch panel 310, a first pair or set for electrodes detect at a first position 610 a change in capacitance indicative of a touch event. As finger 605 continues to move towards touch panel 310, a second pair or set of electrodes detect at a second position 620 a change in capacitance indicative of a touch event. Thus, for the same touch event, two separate capacitance changes can be detected. Knowing a distance between the first position 610 and the second position 620 it is possible to calculate a time difference between the two instances of capacitance change due to the touch event. The calculated time can be considered a speed since the distance over which the touch event occurred is known, i.e., the distance between the first position 610 and the second position 620 is known. Knowing how quickly a user moves a finger for a touch event can be used to enhance an application running on touch device 300 and thus enhance a user's experience. That is, a value of the calculated speed can be provided to an application running on touch device 300 and used thereby.

Referring yet again to FIG. 4, and in accordance with the foregoing, after detecting a touch event with the first and the second detecting capacity to obtain a first detecting result and a second detecting result, at step S430, a status of the touch event according to the first and the second detecting result may be determined. In the case of the forgoing explanation, the status of the touch event might be a speed at which the touch event occurred.

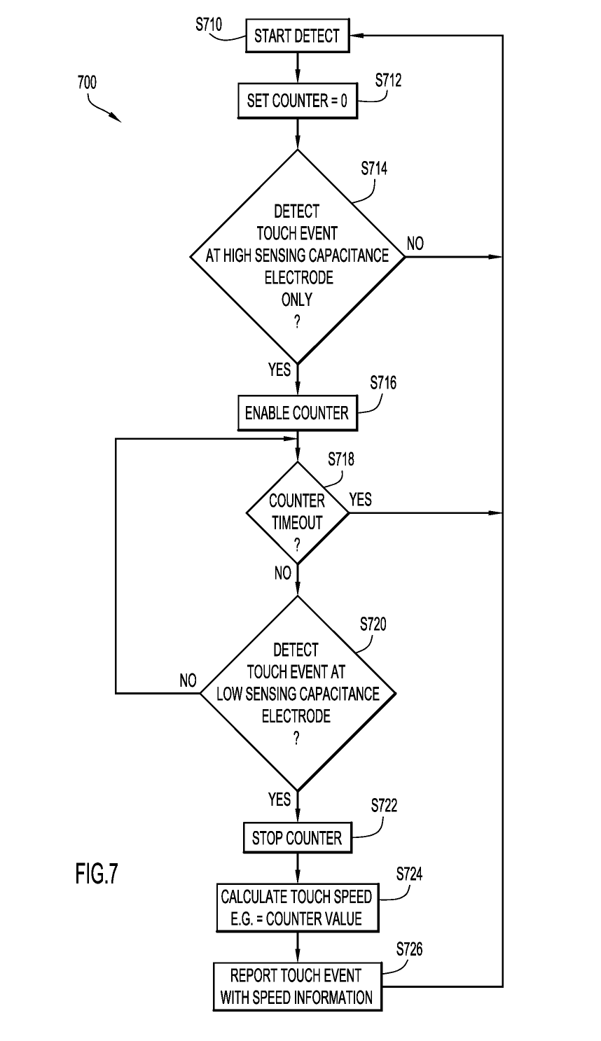

FIG. 7 depicts a flowchart consistent with a touch detection method in accordance with an embodiment of the present invention. As shown in FIG. 7, a process 700 begins at step S710 at which touch event detection starts. At step S712, a counter is set to zero. This counter operates effectively as a “stopwatch” to measure the time between detection of a capacitance change by the first detection electrodes and the second detection electrodes. That time is indicative of the speed with which a finger or other touch device approaches the touch panel. At step S714 it is determined whether a touch event has been detected by the first detection electrodes (i.e., the higher level capacity electrodes) only. By detecting a capacitance change preliminarily and only by the first detection electrodes, it is possible to reduce or eliminate false positive touch event detections. If there is no detection of capacitance change by the first detection electrodes, then process 700 returns to step S710. That is, where there has been no detection of a capacitance change for the first (higher) level capacitance 510, it can be assumed that no touch event at all has occurred and thus there is no touch event for which to calculate a time difference. Consequently, the counter remains at zero. Effectively, in one embodiment, step S714 is repeated until a change for the first (higher) level capacitance has been detected.

Upon detection of a change in capacitance for the first (higher) level capacitance, process 700 proceeds to step S716 where the counter is enabled. The speed at which counter counts may be on the order of microseconds or milliseconds depending on the application. A system clock that is used to operate the touch device may be used to clock the counter. At step S718 it is determined whether the counter has timed out. That is, it is possible that a user (or noise) causes false positive detection of a touch event. It can be assumed that the touch event is a false positive because there is too much time between detection by the first detection electrodes and the second detection electrodes. If the counter has timed out, then process 700 returns to step S710 to restart the entire process and so that the counter is once again reset to zero.

If the counter has not timed out at step S718, process 700 continues with step S720 at which it is determined whether a touch event has been detected by the second detection electrodes (i.e., the lower level capacity electrodes). That is, a finger (or other touching device) has not only caused a capacitance change in the first detection electrodes, but has also caused a capacitance change in the second detection electrodes, within a time span that is less than the counter timeout period. If no detection of a touch event is made by the lower sensing capacity electrodes, then process 700 moves back to step S718. Otherwise, “complete” touch event detection (both the high capacitance and low capacitance electrodes have detected a same touch event) is considered to have occurred and at step S722, the counter is stopped. Then at step S724 a touch speed is calculated. In this case, the touch speed calculation may simply be equating the speed with the value of the counter. However, in other embodiments, there may be a more sophisticated calculation in which a first clock value is subtracted from a second clock value to obtain a difference between the time at which the first detection electrodes detected a touch event and the time at which the second detection electrodes detected a touch event.

Finally, at step S726, the “complete” touch event along with speed information is reported to the application running on the touch device.

It is noted that the foregoing embodiments only describe two different capacitive sensing levels (fields) for a touch panel. However, those skilled in the art will appreciate that more than two different levels of capacitive sensing levels can be implemented.

Further, the foregoing embodiments are applicable to any suitable touch panel including glass-film-film (GFF), one glass solution (OGS) and glass film (GF) panels.

Further still, as explained above, the higher and lower detection electrodes are arranged in different intermingled locations. Such an implementation may be referred to as “space division multiplexing.” However, it is also possible to implement the concepts of the present invention via time division multiplexing.

More specifically, rather than having different shaped electrodes, for example, to achieve space division multiplexing, higher and lower electric fields can be alternately generated time-wise with the electrodes of the touch panel. That is, the touch panel can be configured to generate a higher field across all electrodes over a first working period, and to generate a second lower field across all electrodes over a second working period. The higher and lower fields can be achieved by applying higher and lower voltages to the electrodes. As long as the frequency of the alternating periods is sufficiently high, a time difference between detection at the higher field and the lower field can be calculated in a manner similar to the methodology described above. The timing and level of the different fields (capacitances) can be controlled by processor 320 via, e.g., firmware or software.

The above description is intended by way of example only.

What is claimed is:

1. A method of operating a touch device having a touch panel, comprising:
setting a first capacitance level for the touch panel;
setting a second capacitance level for the touch panel, wherein the first capacitance level is higher than the second capacitance level;
detecting a touch event with respect to the first capacitance level at a first time;
detecting the touch event with respect to the second capacitance level at a second time; and
determining a speed at which the touch event occurred by determining a time difference between the first time and the second time.

2. The method of claim 1, further comprising setting the first capacitance level and the second capacitance level by applying a different voltage to first touch detection electrodes and second touch detection electrodes.

3. The method of claim 1, further comprising setting the first capacitance level and the second capacitance level by applying a different voltage to touch detection electrodes during a first working period and a second working period.

4. The method of claim 1, further comprising setting the first capacitance level and the second capacitance level by forming first detection electrodes and second detection electrodes with differently sized areas.

5. The method of claim 1, further comprising setting the first capacitance level and the second capacitance level by forming first detection electrodes and second detection electrodes with different materials.

6. The method of claim 1, further comprising enabling a counter upon detecting the touch event with respect to the first capacitance level.

7. The method of claim 6, further comprising, resetting the counter to zero after a predetermined timeout period.

8. The method of claim 6, further comprising, upon detecting the touch event with respect to the second capacitance level, stopping the counter.

9. The method of claim 1, further comprising reporting to an application running on the touch device the touch event and speed information for the touch event.

10. The method of claim 1, wherein determining a speed at which the touch event occurred by determining a time difference between the first time and the second time comprises subtracting the second time from the first time.

11. A touch device, comprising:
a touch panel; and
a processor coupled to the touch panel, wherein the processor is configured to:
set a first capacitance level for the touch panel;
set a second capacitance level for the touch panel, wherein the first capacitance level is higher than the second capacitance level;
detect a touch event with respect to the first capacitance level at a first time;
detect the touch event with respect to the second capacitance level at a second time; and
determine a speed at which the touch event occurred by determining a time difference between the first time and the second time.

12. The touch device of claim 11, wherein the processor is further configured to set the first capacitance level and the second capacitance level by applying a different voltage to first touch detection electrodes and second touch detection electrodes.

13. The touch device of claim 11, wherein the processor is further configured to set the first capacitance level and the second capacitance level by applying a different voltage to touch detection electrodes during a first working period and a second working period.

14. The touch device of claim 11, wherein the first capacitance level and the second capacitance level are achieved by forming first detection electrodes and second detection electrodes with differently sized areas.

15. The touch device of claim 11, wherein the first capacitance level and the second capacitance level are achieved by forming first detection electrodes and second detection electrodes with different materials.

16. The touch device of claim 11, wherein the processor is further configured to enable a counter upon detecting the touch event with respect to the first capacitance level.

17. The touch device of claim 16, wherein the processor is further configured to reset the counter to zero after a predetermined timeout period.

18. The touch device of claim 16, wherein the processor is further configured to, upon detecting the touch event with respect to the second capacitance level, stop the counter.

19. The touch device of claim 11, wherein the processor is further configured to report to an application running on the touch device the touch event and speed information for the touch event.

20. The touch device of claim 11, wherein the processor is further configured to determine a speed at which the touch event occurred by subtracting the second time from the first time.
